(19) United States
(12) Patent Application Publication
(10) Pub. No.: US 2025/0303409 A1
(43) Pub. Date: Oct. 2, 2025

(54) MICROFLUIDIC METHODS

(71) Applicant: Seagate Technology LLC, Fremont, CA (US)

(72) Inventors: Brett R. HERDENDORF, Mound, MN (US); Riyan Alex MENDONSA, Edina, MN (US)

(21) Appl. No.: 18/621,042

(22) Filed: Mar. 28, 2024

(51) Int. Cl. B01L 3/00

(52) U.S. Cl. CPC B01L 3/502715; B01L 3/50273; B01L 2400/0439

(57) ABSTRACT

Methods that facilitate the movement of droplets in a digital microfluidic process, such as a lab-on-a-chip system. The methods also allow for a decrease in the minimum droplet size, allowing for the use of smaller fluid droplets in the microfluidic processes. An oscillation or vibration device, such as a piezo-electric device, is used to produce an oscillation in the lab-on-a-chip that disturbs the fluid droplet, allowing easier and better movement of droplets, which allows use of smaller droplets.

### BACKGROUND

Digital microfluidics is a platform for lab-on-a-chip systems that is based upon the manipulation of microdroplets, usually sized from picoliters to microliters, but in some cases envisioned to go down to femtoliters. The droplets are dispensed, moved, stored, mixed, reacted, and/or analyzed on a platform with a set of insulated electrodes. Digital microfluidics is slowly being used for more operations, particularly in drug discovery, DNA computation and data storage, and other lab-on-a-chip technologies.

One of the limitations of digital microfluidics is the minimum droplet size that can be used. A low surface tension is needed to enable movement of the droplet; unfortunately, as the droplet size decreases, the surface tension increases. Because of this, many digital microfluidic operations use larger quantities of reagents and materials than needed, wasting the materials and possibly detrimentally affecting the operations, thus decreasing the effectiveness of microfluidics and limiting the potential of the process. Even with operations that use larger droplets, the surface tension, physical and compositional variations, and age/usage of the “chip” can make the process less reliable than other technologies.

### SUMMARY

This disclosure is directed to methods that facilitate the movement of droplets in a digital microfluidic process, such as a lab-on-a-chip system. The methods also allow for a decrease in the minimum droplet size, allowing for the use of smaller fluid droplets in the microfluidic processes. An oscillation device, such as a piezo-electric device, is used to produce an oscillation, vibration, or actuation in the lab-on-a-chip that disturbs the fluid droplet, allowing easier and better movement of droplets, which allows use of smaller droplets.

One particular implementation described herein is a microfluidic lab-on-a-chip having a hydrophobic fluidic platform with a plurality of individually controllable electrodes operably connected to a voltage source and a controller for the voltage source, a cover slip spaced from and parallel to the platform, and an oscillation source operably connected to the platform or the cover slip.

Another particular implementation described herein is a microfluidic lab-on-a-chip having a hydrophobic fluidic platform with a plurality of individually controllable electrodes operably connected to a voltage source and a controller for the voltage source, at least one fluid inlet operably connecting a liquid source to the fluidic platform, a cover slip spaced from and parallel to the platform, and a piezo-electric or microelectromechanical oscillation device operably connected to the cover slip.

Another particular implementation described herein is a method of moving a droplet on a lab-on-a-chip. The method includes moving a droplet on a lab-on-a-chip moving, via voltage, a droplet from a first inlet across a hydrophobic fluidic platform below a cover slip, and during the moving, applying an oscillation to the droplet via a piezo-electric or microelectromechanical oscillation device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWING

The described technology is best understood from the following Detailed Description describing various implementations read in connection with the accompanying drawing.

FIG. 1A is a schematic, top view of a lab-on-a-chip system showing droplet movement; FIG. 1B is a schematic, side view of the lab-on-a-chip system.

FIG. 2 is an enlarged, top view of a portion of a lab-on-a-chip system.

FIGS. 3A and 3B are further enlarged, top views of a portion of a lab-on-a-chip system illustrating droplet movement without and with movement assist, respectively.

### DETAILED DESCRIPTION

As indicated above, a lab-on-a-chip system and methods of moving droplets are provided herein. The system includes an oscillation device that could be, for example, a piezo-electric device, voice coil or motor, to vibrate, oscillate, or actuate an element of the system, such as a top or cover slip of the system, to reduce surface tension of a droplet and thus facilitate movement of the droplet. Although the terms “oscillate” and “oscillation” are used hereinafter, it is not necessary that the motion imparted by the oscillation device is a true oscillation, having a symmetrically periodic pattern. In some embodiments, the movement may have varying period and/or amplitude. The oscillation may be in two dimensions or in three dimensions.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

Lab-on-a-chip is a common term for an integrated circuit (“chip”) on which one or several laboratory functions or chemical reactions are done. Labs-on-a-chip handle extremely small fluid volumes (e.g., often measured as pico-liters) and are often called microfluidic systems or digital microfluidic systems. In digital microfluidics, the lab-on-a-chip has a hydrophobic “chip platform” on which fluid droplets (e.g., liquid droplets) can be manipulated by precisely controlled voltage application. The platform may have a cover plate covering the fluidic area. By utilizing the feature of surface tension of the fluid on the platform, the fluid can be precisely moved across the platform by voltage applied to the platform, e.g., in a grid.

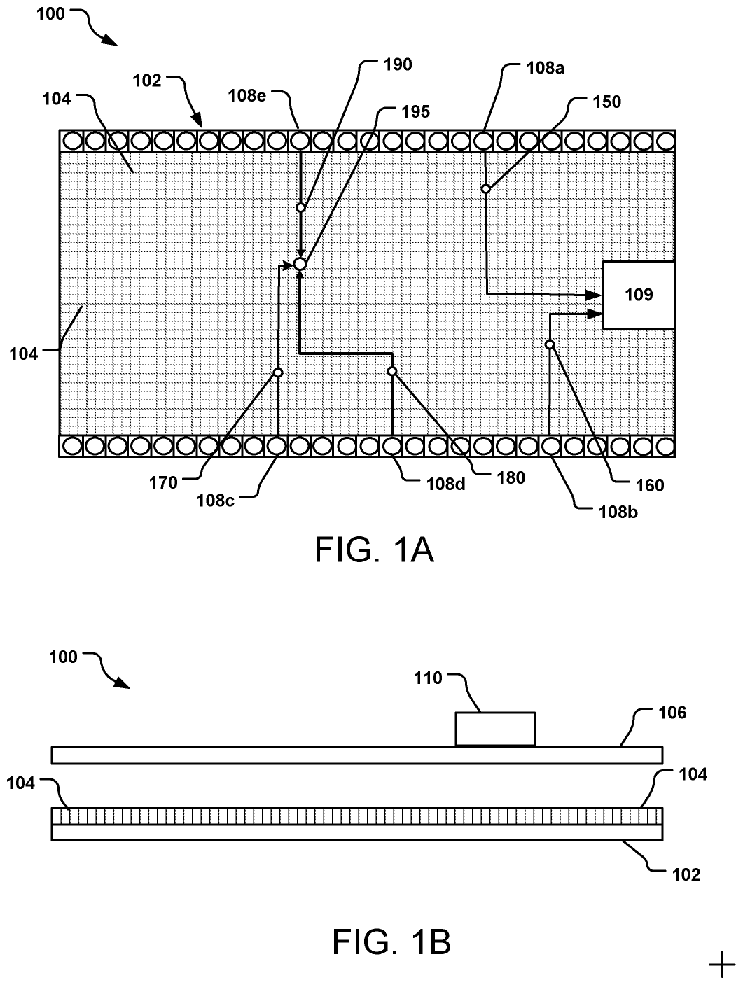

FIGS. 1A and 1B show a lab-on-a-chip 100 with a platform working surface 102 having numerous cells or electrodes 104 thereon, each electrode 104 each configured for independently receiving a voltage from a voltage source (not shown). A top or cover slip 106 is spaced from and parallel to the working surface 102. A plurality of reagent wells 108 are present at edges of the working surface 102, the wells 108 configured to retain a volume of reagent or other fluid. An inlet (not called out) connects each well 108 to the working surface 102. A dedicated mixing location 109 is provided, e.g., for the final mixing of reagents, although mixing of reagents can also be done on the working surface 102. In this implementation, an oscillation source, such as a piezo-electric element 110, is operably connected to the cover slip 106. In some embodiments, the oscillation source is physically connected to the cover slip 106.

One suitable (physical) size for the lab-on-a-chip 100 is about 20 mm by 20 mm, which could have 785,000 electrode elements 104, each electrode 104 having controllable voltage independently applied thereto. In some implementations, each well 108 or other storage compartment for a reagent or fluid is 10×-100× the size of an electrode 104. A stacked or otherwise three-dimensional array of labs-on-a-chip would increase density and decrease required area for the process. A drop elevator could be used to provide synthesis on multiple vertically stacked levels.

Using known techniques (e.g., voltage differential on the platform, e.g., the electrodes 104), a fluid from a well 108 is dispensed through the respective inlet to the working surface 102 and is moved on (across) the surface 102 to a location, e.g., to be mixed with another fluid. FIG. 1A schematically shows the basic movement of fluid droplets on the lab-on-a-chip 100.

In a first step of a method, a selected reagent droplet 150 is moved via voltage on the surface 102 from a well 108a connected via an inlet (not called out) to the mixing location 109. Another droplet 160 (also moved via voltage on the platform surface 102) is also moved to the mixing location 109 from a well 108b. In a second step, the droplets 150, 160, at the mixing location 109, are mixed or combined.

In an alternate method, another selected reagent droplet 170 is moved from a well 108c via voltage on the surface 102 to meet and combine with additional droplets 180, 190 (also moved via voltage on the platform surface 102 from wells 108d, 108e, respectively). The droplets 170, 180, 190 are combined on the surface 102, by moving both droplets 170, 180, 190 to the same location, thus forming a larger droplet 195.

Hundreds of droplets may be moving on the surface 102 simultaneously; for clarity of understanding and to simplify the figure, FIG. 1A shows two droplets 150, 160 moving to the mixing location 109 and three droplets 170, 180, 190 mixing on the platform surface 102. Because of the need to move and/or mix numerous reagents, numerous paths are used. In some implementations, these paths are not constrained by channels or other physical or set paths on the platform 102, but movement of the fluids on the platform 102 is controlled merely by the location of the electrodes 104 and the voltage applied thereto. In other implementations, the paths are at least partially defined.

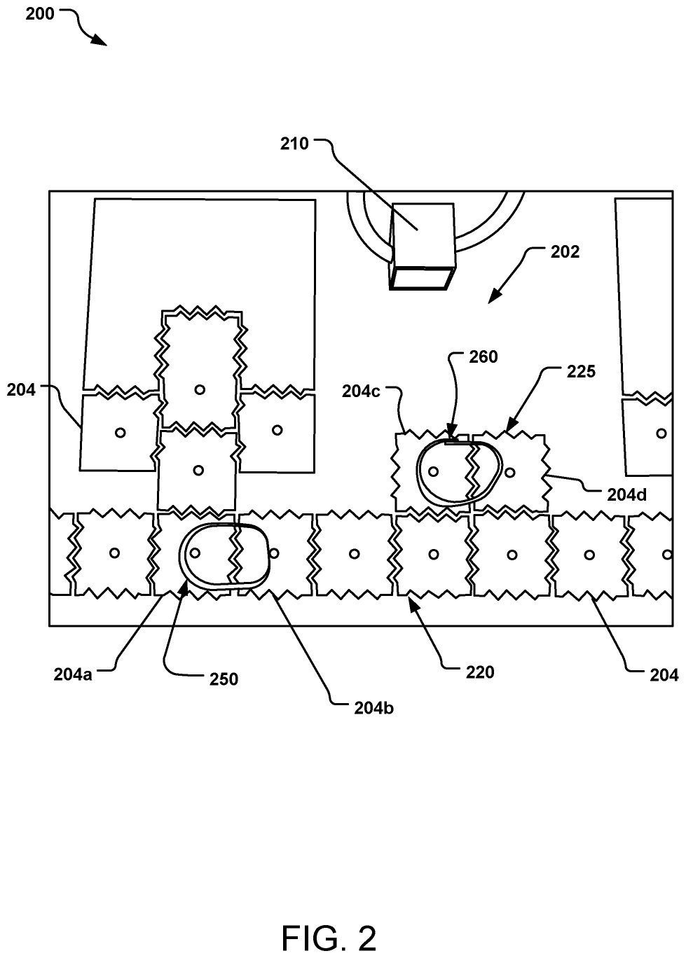

FIG. 2 shows a lab-on-a-chip 200 with a platform working surface 202 having numerous cells or electrodes 204 each configured for independently receiving a voltage. In this design, the entire area of the surface 202 does not have the electrodes 204 thereon, but rather, the electrodes 204 are arranged to form paths 220 and mixing areas 225. Additionally, not all the electrodes 204 are the same shape and/or size. In this implementation, the electrodes 204 have some non-linear edges, which fit or mesh together, like puzzle pieces.

Two droplets are shown in FIG. 2 on the surface 202. A droplet 250 is shown extending over two electrodes 204a and 204b in the path 220; the droplet 250 may be moving from one electrode 204a to the other electrode 204b.

Another droplet 260 is shown extending over two electrodes 204c and 204d; this droplet 260 may be temporarily parked on these electrodes 204c, 204d to allow the droplet 250 or yet another droplet (not shown) to pass on the path 220, or, the droplet 260 may be waiting for another droplet (not shown) with which to be mixed on the electrodes 204c, 204d.

The lab-on-a-chip 200 of FIG. 2 includes an oscillation or vibration device 210 attached to a feature of the chip 200; in this particular design, the device 210 is a piezo-electric device 211 attached to the top or cover slip (not called out). In other implementations, the oscillation device 210 can be attached to the working surface 202. The oscillation device 210 facilitates movement of the droplets 250, 260 along the electrodes 204 by oscillating the droplets 250, 260 and reducing their surface tension. By reducing the surface tension, the wetting angle changes, allowing easier movement of the droplets along the working surface 202.

In this particular implementation of FIG. 2, the piezo-electric device 210 is attached to the top or cover slip of the lab-on-a-chip. Due to surface tension and other properties of the droplet, although the droplet is seated on the working platform 202 of the lab, a portion of the droplet is in contact with the top cover slip. By oscillating the cover slip, the droplet is directly oscillated. In other implementations, the droplet is indirectly oscillated. For example, if the size or volume of the droplet is sufficiently small or the wetting angle of the droplet is sufficiently low that the droplet does not contact the top cover slip, oscillation from the top cover slip may nonetheless affect the droplet.

In one implementation, the piezo-electric device oscillates the cover slip at or approximately at the harmonic frequency of the cover slip. For example, a glass cover slip may have a harmonic frequency of approximately 4,000 Hz. In another implementation, the piezo-electric device oscillates the cover slip at or approximately at the second harmonic frequency of the cover slip, e.g., approximately 8,000 Hz, or at the third harmonic frequency. The oscillation may be in the x-y direction of the cover slip, or may be in the z-direction toward the platform.

In alternate implementations, rather than having the oscillation frequency be at or near a resonant frequency of the surface to which the agitation device is connected or of a surface that the droplet contacts, the oscillation energy and frequency can be adjusted to be at a resonant frequency of the droplet based on, e.g., the viscosity, size/volume, and energy absorption capability of the droplet.

The surface on which the piezo-electric device is located may include a surface coating to increase the electrical conductivity of the surface. Additionally or alternately, any surface that would contact the droplets may be provided with a coating. For example, a glass cover slip may include a conductive, sputtered coating such as indium tin oxide (ITO). As another example, a polymeric working platform may include a low surface energy coating, such as a silicone-base coating, or a high energy surface coating.

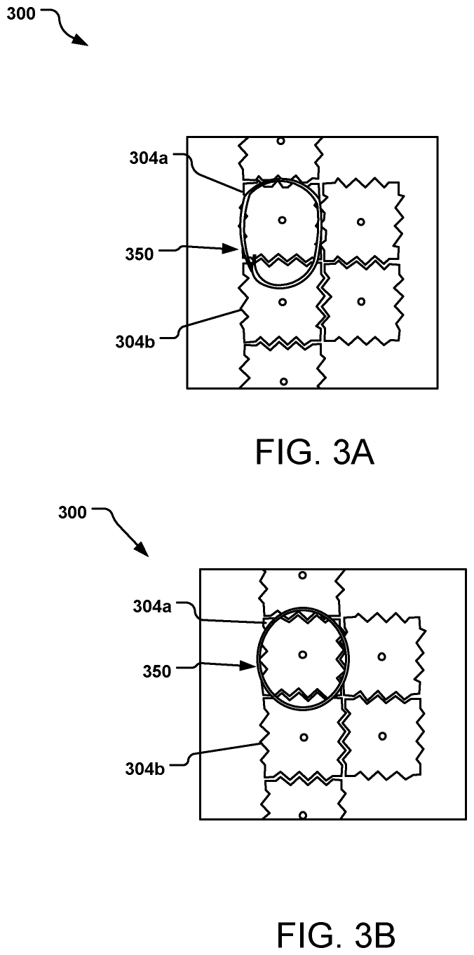

FIGS. 3A and 3B show an example of the benefit on droplet movement when utilizing an oscillation device added to the voltage with an AC component; in particular, FIGS. 3A and 3B show the same droplet movement made with an AC component to the applied voltage-only (FIG. 3A) and with an AC component to the applied voltage in addition to oscillation assist (FIG. 3B).

In FIG. 3A, a portion of a lab-on-a-chip 300 is shown, particularly, a plurality of electrodes 304 with a droplet 350 thereon are seen. The droplet 350 is seen occupying predominantly all of an electrode 304a and overspilling onto an electrode 304b. It is theorized that the fluid properties (e.g., overspilling onto the adjacent electrode) is due to the sluggish motion of the droplet 350 in the given time period without any assist apart from the AC component of the applied voltage.

In FIG. 3B, an energy-generating device, such as a piezo-electric device, (not shown) is activated, thus providing an oscillation or vibration to the droplet 350. The droplet 350 is here seen occupying all of the electrode 304a with little overspill onto the electrode 304b. The oscillation-assisted movement pulls more of the droplet 350 on to the target electrode 304a and fills the edge serpentine area, which will help the subsequent movement of the droplet 350. It is theorized that the tighter fluid properties are due to the system having sufficient energy due to the added oscillation, so that the droplet is able to fully move in the given time period onto the electrode 304a.

As discussed above, one of the issues with digital microfluidic systems, such as the labs-on-a-chip discussed above, is that the surface tension of the droplet limits the possible minimum drop size and thus the reliability of movement and mixing of the droplet. The external agitation, oscillation, or vibration source (e.g., a piezo based mechanical agitation) provides agitation to the droplet, which changes the wetting angle, so that it can be more easily moved in a controlled manner compared to without this additional agitation. Additionally, the agitation to the droplet allows use of a decreased droplet size. This improvement is seen as a drop in voltage requirements and increased speed of droplet movement across the working platform.

Although the previous discussion has been based on utilizing a mechanical oscillation (e.g., a piezo-electric device or other microelectromechanical (MEMS) device), other sources of energy can be used to impart the energy to the droplet to enhance its motion, through means like oscillation or change in effective viscosity or surface tension. Examples of other vibration, agitation or oscillation sources are electrostatic, acoustical (producing sound waves), magnetic or electromagnetic (especially if there are magnetic nanoparticle (MNPs) in suspension in the droplet), optical (e.g., optical tweezers), and thermal. The energy source can be such that it effects the whole lab on a chip structure or is directed toward specific droplets or even in a specific direction.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. A microfluidic lab-on-a-chip comprising:
a hydrophobic fluidic platform comprising a plurality of individually controllable electrodes operably connected to a voltage source and a controller for the voltage source;
a cover slip spaced from and parallel to the platform; and
an oscillation source operably connected to the platform or the cover slip.

2. The microfluidic lab-on-a-chip of claim 1 wherein the oscillation source is operably connected to the cover slip.

3. The microfluidic lab-on-a-chip of claim 1 wherein the oscillation source is a piezo-electric device.

4. The microfluidic lab-on-a-chip of claim 1 wherein the oscillation source is physically connected to the platform.

5. The microfluidic lab-on-a-chip of claim 1 wherein the oscillation source is an electrostatic source.

6. The microfluidic lab-on-a-chip of claim 1 wherein the oscillation source is a magnetic source.

7. The microfluidic lab-on-a-chip of claim 1 wherein the oscillation source is an acoustical source.

8. The microfluidic lab-on-a-chip of claim 1 wherein the oscillation source is a microelectromechanical device.

9. A microfluidic lab-on-a-chip comprising:
a hydrophobic fluidic platform comprising a plurality of individually controllable electrodes operably connected to a voltage source and a controller for the voltage source;
at least one fluid inlet operably connecting a liquid source to the fluidic platform;
a cover slip spaced from and parallel to the platform; and
a piezo-electric or microelectromechanical oscillation device operably connected to the cover slip.

10. The microfluidic lab-on-a-chip of claim 9, wherein the oscillation device is configured to oscillate the cover slip at a harmonic frequency of the cover slip.

11. The microfluidic lab-on-a-chip of claim 10, wherein the oscillation device is configured to oscillate the cover slip at a resonant frequency of the cover slip.

12. The microfluidic lab-on-a-chip of claim 10, wherein the oscillation device is configured to oscillate the cover slip at a harmonic frequency of the cover slip.

13. A method of moving a droplet on a lab-on-a-chip, the method comprising:
moving, via voltage, a droplet from a first inlet across a hydrophobic fluidic platform below a cover slip; and
during the moving, applying an oscillation to the droplet via a piezo-electric or microelectromechanical oscillation device.

14. The method of claim 13, wherein applying the oscillation comprises applying the oscillation directly to the droplet.

15. The method of claim 14, wherein applying the oscillation directly to the droplet comprises applying the oscillation to the cover slip.

16. The method of claim 15, wherein applying the oscillation to the cover slip comprises applying an oscillation having a frequency approximately that of a resonant frequency of the cover slip.

17. The method of claim 15, wherein applying the oscillation to the cover slip comprises applying an oscillation having a frequency approximately that of a resonant frequency of the cover slip.

18. The method of claim 14, wherein applying the oscillation directly to the droplet comprises applying the oscillation to the platform.
